(19) United States
(12) Patent Application Publication
(10) Pub. No.: US 2016/0266868 A1
(43) Pub. Date: Sep. 15, 2016

(54) Apparatus, System, and Method for Multi-Zone Audio Playback

(71) Applicant: VSSL LLC, Hurricane, UT (US)

(72) Inventor: Dan Allen, Washington, UT (US)

(73) Assignee: VSSL LLC, Hurricane, UT (US)

(21) Appl. No.: 15/069,942

(22) Filed: Mar. 14, 2016

Related U.S. Application Data
(60) Provisional application No. 62/132,549, filed on Mar. 13, 2015.

(51) Int. Cl. G06F 3/16; H04R 27/00; H04R 3/12; H04L 12/933; H04W 40/22

(52) U.S. Cl. CPC G06F 3/165; H04L 49/109; H04W 40/22; H04R 3/12; H04R 27/00; H04R 2420/07; H04R 2430/01

(57) ABSTRACT

An audio router. The audio router includes a media director and an audio transmission module. The media director configured to receive a signal containing audio information from a source external to the audio router includes a plurality of nodes. Each node includes a network transceiver configured to advertise availability of the node on a data network and an advertisement module configured to advertise availability of the node on the data network. The audio transmission module is configured to transmit the signal containing audio information.

### CROSS-REFERENCE TO RELATED APPLICATIONS

This application claims the benefit of U.S. Provisional Patent Application Ser. No. 62/132,549, filed on Mar. 13, 2015, which is incorporated herein by reference.

### SUMMARY

An embodiment of the invention provides an audio router. The audio router includes a media director and an audio transmission module. The media director configured to receive a signal containing audio information from a source external to the audio router includes a plurality of nodes. Each node includes a network transceiver configured to advertise availability of the node on a data network and an advertisement module configured to advertise availability of the node on the data network. The audio transmission module is configured to transmit the signal containing audio information. Other embodiments are also described.

### BRIEF DESCRIPTION OF THE SEVERAL VIEWS OF THE DRAWINGS

FIG. 1 is a block diagram depicting one embodiment of an audio router.

FIG. 2 is a block diagram depicting another embodiment of an audio router.

FIG. 3 is a block diagram depicting another embodiment of an audio router.

FIG. 4 depicts one embodiment of an audio router 400 interfacing with one or more external nodes.

FIG. 5 illustrates one embodiment of a control path of a system of playing wireless audio to one or more zones.

FIG. 6 is a block diagram depicting one embodiment of a node of FIG. 1.

FIG. 7 is a block diagram depicting one embodiment of the media director of FIG. 1.

FIG. 8 depicts a flowchart diagram showing an embodiment of a method for configuring an audio router.

FIG. 9 is a diagram of one embodiment of a computer system for facilitating the execution of the audio router of FIG. 1.

Throughout the description, similar reference numbers may be used to identify similar elements.

### DETAILED DESCRIPTION

In the following description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

While many embodiments are described herein, at least some of the described embodiments provide

[symbol]

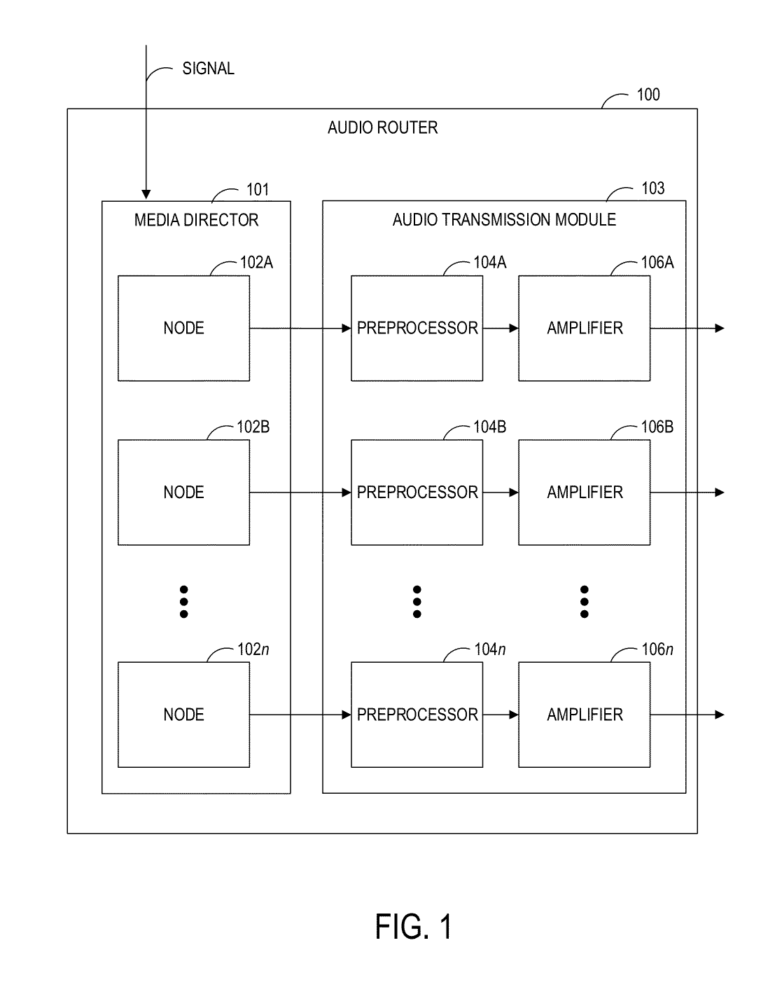

FIG. 1 is a block diagram depicting one embodiment of an audio router 100. The audio router includes a media director 101, and an audio transmission module 103. The audio router 100 receives a signal containing audio information from an external source and distributes it through one or more outputs for playback on one or more playback devices.

The media director 101, in certain embodiments, includes one or more nodes 102A-102n, collectively 102. The media director 101 receives the signal containing audio information and routes the signal to one or more nodes 102. The media director 101 may route the signal according to a predetermined routing. In some embodiments, the media director routes the signal to a node based on a determination that a user has requested playback of an audio source over a zone including one or more playback devices (not shown) attached to a particular node 102.

The nodes 102, in one embodiment, include a processor for processing the audio signal and/or routing the audio signal to one or more other components of the audio router 100. Each node 102 may include a microprocessor. In some embodiments, each node 102 includes a system on a chip (“SoC”) incorporating many functions of a computing device into a relatively compact package.

In some embodiments, the node 102 includes one or more hardware components for processing audio. For example, the node 102 may include a microprocessor configured to transcode a signal containing audio information from one protocol to another protocol.

The audio transmission module 103, in some embodiments, includes one or more preprocessors 104A-104n, collectively 104 and one or more amplifiers 106A-106n, collectively 106. The audio transmission module 103 transmits the signal containing audio information. In some embodiments, the audio transmission module 103 transforms the signal containing audio information to generate a signal derived from the signal containing audio information.

Each of the preprocessors 104, in certain embodiments, are configured to process the audio signal provided by a node 102. A preprocessor 104 may provide equalization, normalization, antialiasing, decoding, or other processing for the audio signal. In some embodiments, each of the preprocessors 104 are a discrete component or set of components in the audio router 100, such as one or more electronic components electrically connected to the audio router 100. In an alternative embodiment, the preprocessors 104 are a logical construct operating as part of a larger system providing additional features and operations.

Each of the amplifiers 106, in one embodiment, are configured to amplify an audio signal for deliver to one or more playback devices. The amplifiers 106 may be any type of amplifier known in the art. In some embodiments, each of the amplifiers 106 are a discrete component or set of components in the audio router 100, such as one or more electronic components electrically connected to the audio router 100. In an alternative embodiment, the amplifiers 106 are a logical construct operating as part of a larger system providing additional features and operations.

In the illustrated embodiment, the preprocessors 104 and amplifiers 106 are components of the audio router 100. In an alternative embodiment, either of both of the preprocessors 104 or the amplifiers 106 may be components separate from the audio router 100. For example, the audio router 100 may route an audio signal to an external device incorporating a preprocessor, an amplifier, and a speaker.

In some embodiments, an external signal containing audio information is received by the audio router. The signal containing audio information is routed to a node 102 in communication therewith. The signal containing audio information may be transmitted using a transmission standard capable of audio synchronization. Routing may be accomplished by using standard wireless protocols (e.g., using a Wi-Fi® subsystem, antennas, etc.) on each node 102. The audio signal then passes from the node 102 to a preprocessor 104, to an amplifier 106, where it is then transmitted to one or more speakers. The nodes may also form a mesh network, such as by using a networking protocol for multi-room syncing.

As an example of use, a user desiring to play music in one location or “zone” of a house, such as the kitchen, can connect to the appropriate node 102 for that zone with a networkable user device using wireless protocols. This allows a user to play and control the music in that zone using their networkable user device, such as smartphone or tablet, without any specialized control software. For example, the user can provide media to the audio router 100 using native streaming apps to the phone which are developed and maintained by independent media streaming companies such as Spotify or Pandora. The native streaming apps may provide an audio signal compliant with an audio streaming standard. The audio streaming standard may be any type of audio streaming standard, including, for example, an open standard or a proprietary standard. The audio signal may be delivered to the audio router 100 through digital protocols such as Airplay and or the like.

In some embodiments, the audio router is capable of routing more than one signal simultaneously. For example, at the same time a user in a kitchen zone is streaming a particular audio stream to playback devices in the kitchen zone, a user in another zone, such as a bedroom, can likewise connect to the appropriate node 102 and stream audio in his or her zone without interfering with the first user's playback in the kitchen. In some embodiments, both users can independently adjust their playback, such as volume levels, EQ settings, etc., without interfering with the other.

Each node 102, in some embodiments, is capable of receiving external signals containing audio information complying with multiple protocols, including, for example, Airplay, DLNA, Miracast, Samsung Link, Google Cast, and the like. Also, as mentioned earlier, each node 102 may also be capable of networking with one or more additional nodes 102 and also of creating a mesh network. Further, in certain embodiments, each node 102 can network with other nodes residing on external devices, such as a speaker, a subwoofer, or in another audio router. Mesh networking is particularly useful for syncing audio playback to more than one zone by using more than one node 102 (and on external devices). However, audio syncing can also occur over existing networking topologies, for example an IP network, and not just mesh networks.

In certain embodiments, a user may direct the audio router 100 to simultaneously route audio derived from an external signal containing audio information to more than one zone (i.e., a “party zone”). For example, a user would connect to a node preconfigured to play audio on more than one zone through communications with two or more additional nodes 102. For example, a user could wirelessly connect their networkable user device to the “pool party zone” by connecting to the appropriate node 102, with that node 102 being in network communication with the appropriate nodes 102 for the outdoor pool, patio, and kitchen zones. By so doing, a user is able to play the same audio across all three zones by simply connecting to the node 102 for the “party zone.” It will be appreciated that the party zone may be configured to include two or more zones and is not expressly limited on the number or zones to include. It will also be appreciated that more than one party zone node may be used. In other words, one party zone may be preconfigured to include the pool party zone as outlined above, while another party zone may be preconfigured to include the upper floor of the house, which includes multiple room zones. In this way, one user can have the music playing in the pool zone, while another user has different audio playing in the upper party zone. Further, it is also possible to expand any given zone by incorporating additional devices having a node, such as subwoofers or speakers.

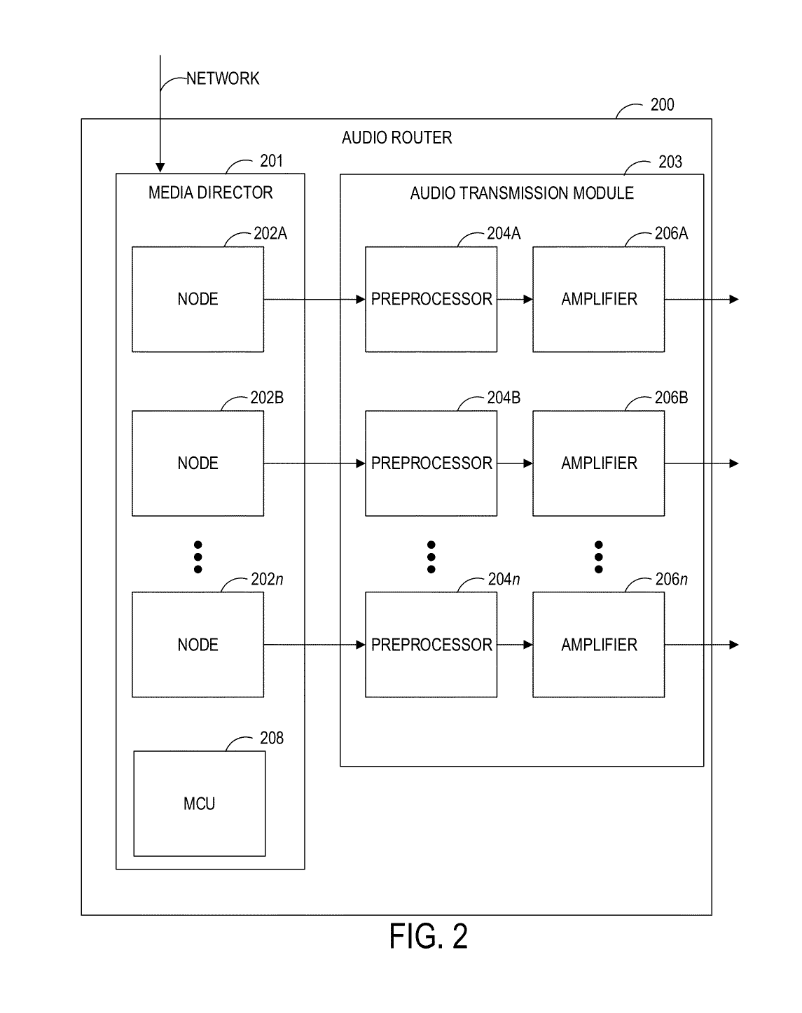

FIG. 2 is a block diagram depicting one embodiment of an audio router 200. The audio router 200 includes a media director 201 and an audio transmission module 203. The audio router 200 receives a signal containing audio information from an external source and distributes it through one or more outputs for playback on one or more playback devices.

The media director 201, in certain embodiments, includes one or more nodes 202A-202n, collectively 202 and a microcontroller 208. The media director 201 receives the signal containing audio information and routes the signal to one or more nodes 202.

The nodes 202, in one embodiment, are connected to an external network (for example an IP-based home network with a wireless router as a hub) via an internal network, such as a Broadcom BCM53128 chip. Each of the nodes 202 are capable of receiving at least one digital media signal from the external network, wherein the input signal is then transmitted to the audio transmission module 203 where the signal is sent to one or more playback devices.

The microcontroller 208, may be any type of microcontroller known in the art, or it may be a specialized microcontroller. In one embodiment, the microcontroller is integrated into the node 202 as a SoC.

In one embodiment, the microcontroller 208 is in communication with the various components of the audio router 200 over a computer bus. For example, the microcontroller may connect to components using Inter-Integrated Circuit (a.k.a. I2C) or its equivalent. The microcontroller 208 is configured to communicate to the components for various reasons; for example, to configure a node 202 (e.g., setting the Zone Name, creating a Party zone, etc.), configure a preprocessor 204 (e.g., equalizer settings), or to configure and monitor an amplifier 206 (e.g., status and health of the amplifier 206).

In some embodiments, the microcontroller 208 is configured to be controlled by an external device, such as a networkable user device such as a smart phone or a tablet connected to the microcontroller through a network connection.

In one embodiment, the microcontroller is configured to receive network commands via tunneling through the network connection of a node 202.

Each node 202, in one embodiment, is capable of receiving a one or more signals containing audio information conforming to multiple standards, including, for example, Airplay, DLNA, Miracast, Samsung Link, Google Cast, and others.

In some embodiments, the audio transmission module 203 is similar to the audio transmission module 103 described above. The audio transmission module 203 may include one or more preprocessors 204A-204n, collectively 204, and one or more amplifiers 206A-206n, collectively 206. In certain embodiments, an amplifier 206 in a sleep state is awakenable in response to receiving a signal.

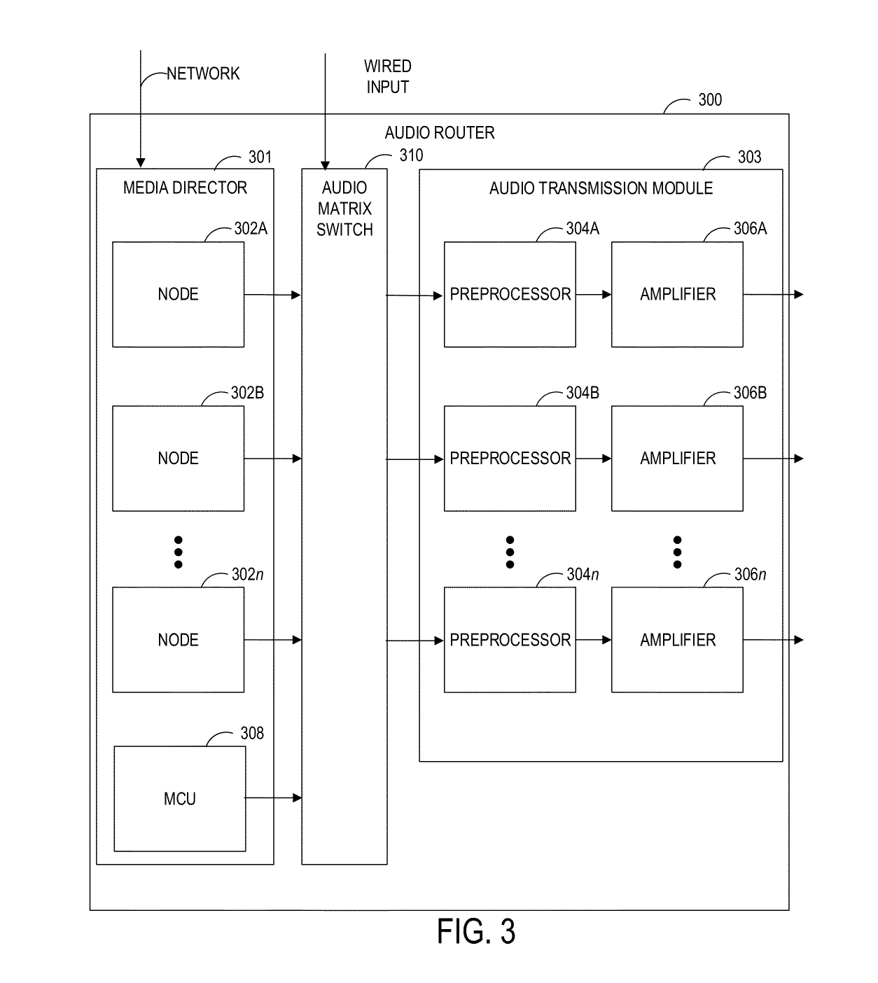

FIG. 3 is a block diagram depicting one embodiment of an audio router 300. The audio router 300 includes a media director 301, an audio transmission module 301, and an audio matrix switch 310. The audio router 300 receives a signal containing audio information from an external source and distributes it through one or more outputs for playback on one or more playback devices.

In some embodiments, the media director 301 and the audio transmission module 303 are similar to like-named components described above in relation to FIGS. 1-2. The audio transmission module may include one or more preprocessors 304A-304n, collectively 304, one or more amplifiers 306A-306n, collectively 306. The preprocessors 304 and the amplifiers 306 may be similar to like-named components described above. The audio matrix switch 310, in one embodiment, receives audio signals and selectively routes the audio signals from one or more nodes 302 to one or more other components.

In some embodiments, the audio matrix switch 310 is configured to receive non-wireless inputs, such as optical, digital coaxial, or analog signals, etc. The audio matrix switch 310 may receive signals from one or more nodes 302 and/or from wired inputs. The audio matrix switch 310 may include a receiver for receiving an audio signal from a wired input, such as an SPDIF receiver, a coaxial receiver, or an optical receiver. In some embodiments, the audio matrix switch includes an analog to digital converter (“ADC”) for converting an analog audio signal to a digital audio signal. The audio matrix switch 310 is configured to process a signal from the wired input route the signal to a predetermined preprocessor 304, to a corresponding amplifier 306, and then to one or more playback devices. A microcontroller 308, in one embodiment, controls the various components, such as the nodes 302, the audio matrix switch 310, and others.

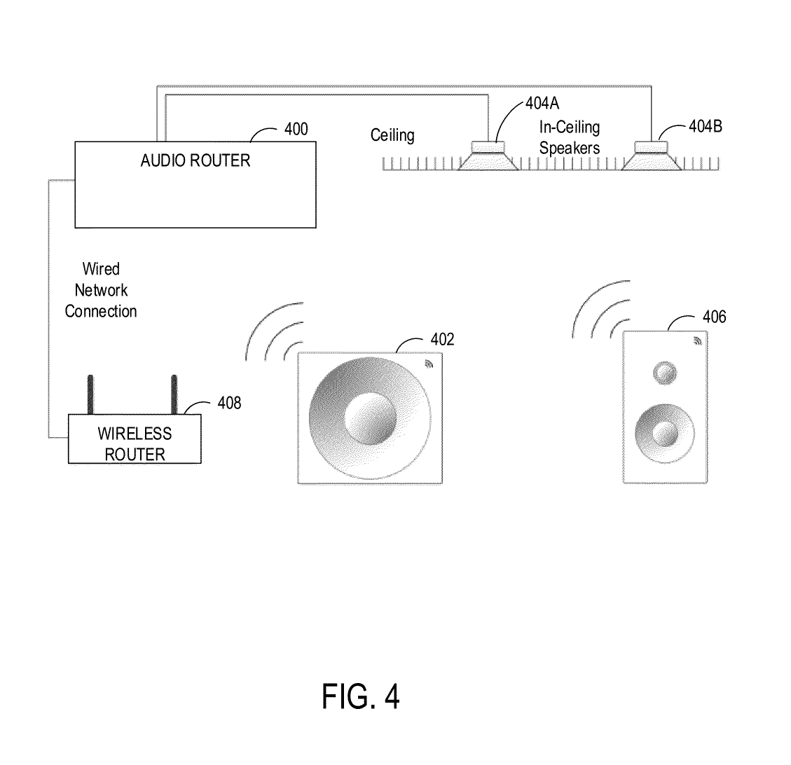

FIG. 4 depicts one embodiment of an audio router 400 interfacing with one or more external nodes. In some embodiments, each node is capable of networking with other nodes external to the audio router 400. For example a subwoofer 402 may include a node that is capable of being on the same network (for example, an IP network or a mesh network) as a node in the audio router 400. This allows audio playback to be played through the subwoofer 402 in sync with the rest of the zone speakers 404A-B. In addition, the subwoofer 402 (or other external audio device, such as a speaker 406) can be in communication with the audio router 400, but it is not required. In other words, any number of networkable audio outputs (e.g., subwoofers, speakers) may be in communication with the audio router 400 for zone playback, but they may also be in communication with a wireless router 408 for similar zone playback. This functionality allows the user to expand the system with additional wireless speakers, which eliminates the need to hardwire additional speakers directly to the networkable amp.

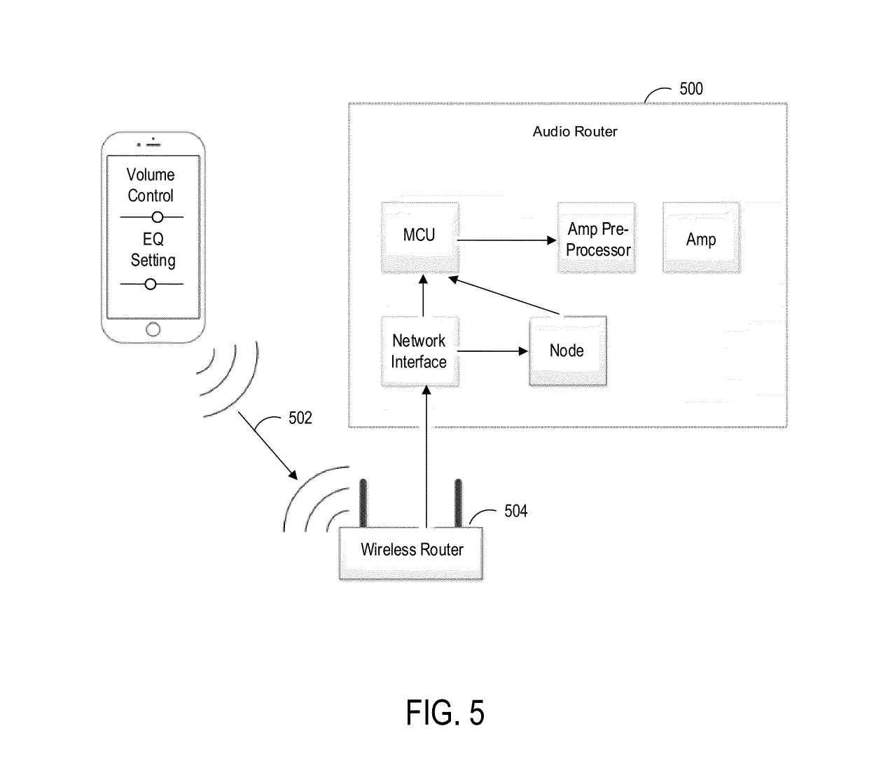

FIG. 5 illustrates one embodiment of a control path of a system of playing wireless audio to one or more zones. For example, a user may transmit a control signal, generally shown at line 502, to a wireless router 504 where the wireless router is part of a local IP network). In response the wireless router 504 may transmit the data to the audio router 500, where it is received and processed. An audio signal may be transferred from the smart phone and received by a node in the audio router 500 (e.g., using Airplay or DLNA). The smart phone may instruct the node where to receive the audio and the node may connect to a server on the internet (such is the case for Google Cast). The audio playback may persist even if the phone leaves the network or if a user gets a call. In one embodiment, the data can also be transmitted to the node and then “tunneled” to the microcontroller. In other words, the node may be capable of receiving network commands for the microcontroller and then the node may transmit commands to the microcontroller via a hardware interface such as UART.

Additional capabilities may also be added to any of the audio routers discussed above, such as the ability to monitor the status of each node, each preprocessor, and each amplifier (such as by using a microcontroller or equivalent means). For example, the microcontroller may be configured to notify a user, such as by sending a signal to the user's electronic device that a channel is failing or that communication to the network is lost.

In one embodiment, a system for audio playback further comprises at least one RF beacon to control the zone selection. In other words, one or more RF beacons would be placed in the various zones. As a user moves from zone to zone, the user's device (e.g., a smartphone or tablet) would then redirect the signal to the appropriate zone. The user's device may be configured to identify which zone a user is in based on a location of the device relative to one or more beacons. Using that information, the system can redirect audio playback to the appropriate zone. For example, standard methods may be used to calculate the distance from any given beacon, such as by the user's device reading the received signal strength indicator (“RSSI”) and measured power from the beacon. The measured power is the average RSSI received at a 1-meter distance. By comparing the actual RSSI with the average RSSI, the device can calculate its distance to the beacon. Software known in the art, such as Apple's iBeacon, may be used for such purposes. As such, if the user's device is closer to one zone beacon than another, the audio router may be configured to route a selected audio signal to the zone with the closest beacon (unless the user instructs the device otherwise).

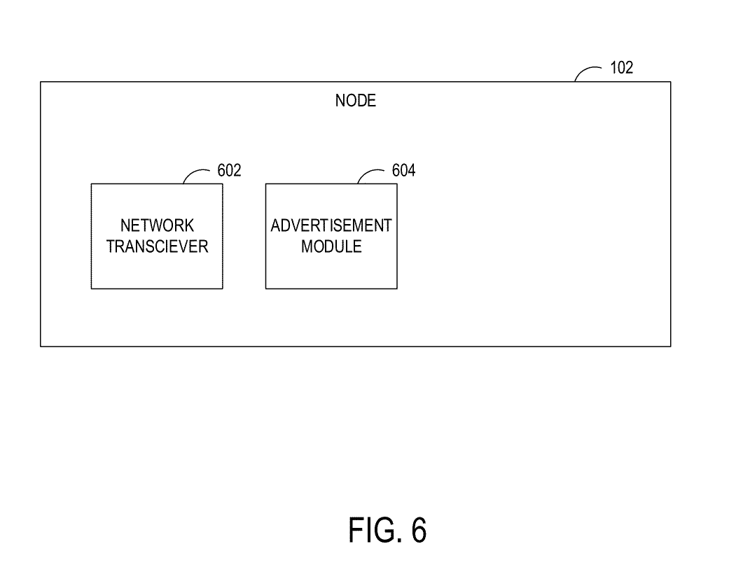

FIG. 6 is a block diagram depicting one embodiment of a node 102 of FIG. 1. The node 102, includes a network transceiver 602 and an advertisement module 604. The node 102 receives a signal containing audio information and routes the signal to one or more other components.

The network transceiver 602, in one embodiment, receives and transmits signal over a network. The network transceiver 602 may transmit network signals using any known standard, including, but not limited to, Ethernet, WiFi, a point-to-point network, or a mesh network. In some embodiments, the network transceiver 602 or another component of the node 102 is capable of sending or receiving signals complying with a wireless communication standard, such as Bluetooth or near field communication (NFC).

The advertisement module 604, in certain embodiments, is configurable to advertise the availability of the node 100 on a data network. The advertisement module 604 may advertise that the node 102 is capable of operating to receive a streaming audio signal compliant with an audio streaming standard. For example, the advertisement module 604 may signal the availability of the node as a Google cast endpoint.

In some embodiments, the advertisement module 604 is configurable to advertise the availability of the node 102 to deliver audio to a predetermined group of playback devices. For example, a group of playback devices may be arbitrarily grouped into a “zone” of playback devices, and the advertisement module 604 may be configured to indicate that it is capable of acting as a receiver for audio to be routed to that zone.

In some embodiments, the node 102 is configurable to route audio to multiple additional nodes. For example, the node 102 may be configurable to deliver audio to three separate nodes.

The node 102 may be configured to deliver audio to any type or number of playback devices. Playback devices may include any type of device capable of reproducing audio, such as a speaker, a television, a sound bar, a subwoofer, a mobile device, an intercom, or the like.

In some embodiments, the node 102 includes a processor capable of modifying the signal containing audio information. For example, the node 102 may transcode the signal to comply with another streaming audio standard. In some embodiments the node 102 delivers the signal containing audio information or a signal derived from the signal containing audio information. In an alternate embodiment, the node 102 delivers a signal containing audio information to an external audio preprocessor.

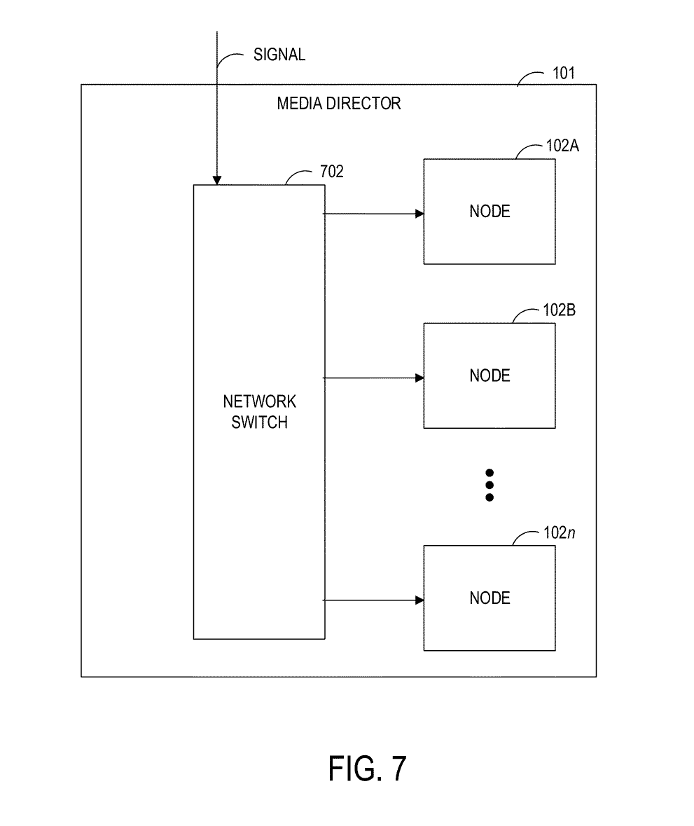

FIG. 7 is a block diagram depicting one embodiment of the media director 101 of FIG. 1. In some embodiments, the media director 101 includes more than one nodes 102A-102n, collectively 102, and a network switch 702. The media director receives and routes a signal containing audio information.

In some embodiments, the nodes 102 are similar to like-named components described in relation to FIGS. 1-3 above. The network switch 702, in one embodiment, receives a network signal and distributes it to the appropriate node 102. The network switch 702 may use any known method of network switching. For example, the network switch may use packet switching.

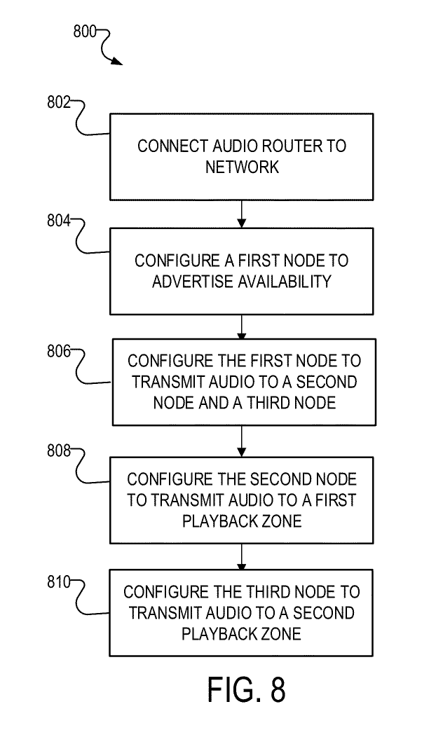

FIG. 8 depicts a flowchart diagram showing an embodiment of a method for configuring an audio router 100. The method is in certain embodiments a method of use of the system and apparatus of FIGS. 1-6, and will be discussed with reference to those figures. Nevertheless, the methods may also be conducted independently thereof and are not intended to be limited specifically to the specific embodiments discussed above with respect to those figures.

FIG. 8 illustrates a method 800 for configuring an audio router 100. As shown in FIG. 8, the audio router 100 is connected 802 to a network. The network may be any type of network capable of delivering a signal containing audio information to the audio router 100, such as the Internet or a local area network.

In some embodiments, a first node 102 is configured 804 to advertise availability of the first node 102 to receive an audio signal. The advertisement may indicate that the first node 102 is capable of receiving a signal compliant with a particular standard.

The first node 102, in some embodiments, is configured 806 to transmit audio to a second node and a third node. The second node and the third node may each be components of the audio router 100 or be external to the audio router 100.

The second node, in one embodiment, is configured 808 to transmit audio to a first playback zone. The first playback zone may include one or more playback devices, such as a speaker.

The third node, in one embodiment, is configured 810 to transmit audio to a second playback zone. The second playback zone may include one or more playback devices, such as a speaker.

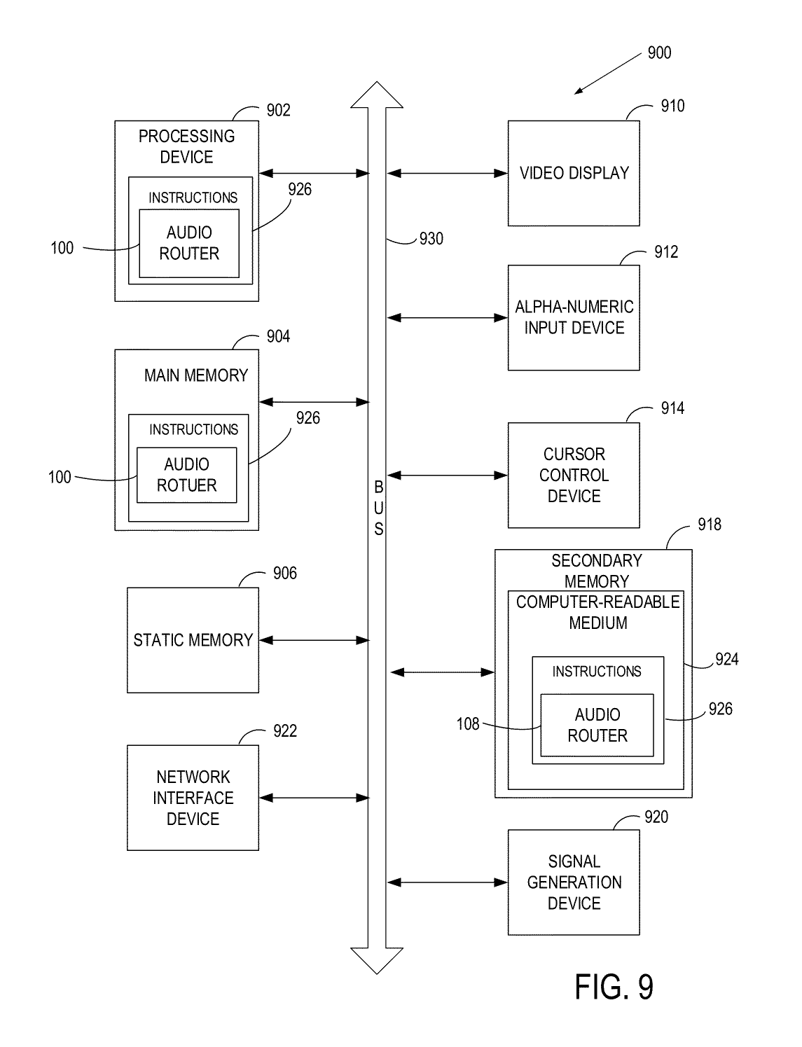

FIG. 9 is a diagram of one embodiment of a computer system 900 for facilitating the execution of the audio router 100 of FIG. 1. Within the computer system 900 is a set of instructions for causing the machine to perform any one or more of the methodologies discussed herein. In alternative embodiments, the machine may be connected (e.g., networked) to other machines in a LAN, an intranet, an extranet, or the Internet. The machine can be a host in a cloud, a cloud provider system, a cloud controller or any other machine. The machine can operate in the capacity of a server or a client machine in a client-server network environment, or as a peer machine in a peer-to-peer (or distributed) network environment. The machine may be a personal computer (PC), a tablet PC, a console device or set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 900 includes a processing device 902, a main memory 904 (e.g., read-only memory (ROM), flash memory, dynamic random access memory (DRAM) such as synchronous DRAM (SDRAM) or DRAM (RDRAM), etc.), a static memory 906 (e.g., flash memory, static random access memory (SRAM), etc.), and a secondary memory 918 (e.g., a data storage device in the form of a drive unit, which may include fixed or removable computer-readable storage medium), which communicate with each other via a bus 930.

Processing device 902 represents one or more general-purpose processing devices such as a microprocessor, central processing unit, or the like. More particularly, the processing device 902 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 902 may also be one or more special-purpose processing devices such as an application specific integrated circuit (ASIC), a field programmable gate array (FPGA), a digital signal processor (DSP), network processor, or the like. Processing device 902 is configured to execute the instructions 926 for performing the operations and steps discussed herein.

The computer system 900 may further include a network interface device 922. The computer system 900 also may include a video display unit 910 (e.g., a liquid crystal display (LCD) or a cathode ray tube (CRT)) connected to the computer system through a graphics port and graphics chipset, an alphanumeric input device 912 (e.g., a keyboard), a cursor control device 98 (e.g., a mouse), and a signal generation device 920 (e.g., a speaker).

The secondary memory 918 may include a machine-readable storage medium (or more specifically a computer-readable storage medium) 924 on which is stored one or more sets of instructions 926 embodying any one or more of the methodologies or functions described herein. In one embodiment, the instructions 926 include instructions for the audio router 100. The instructions 926 may also reside, completely or at least partially, within the main memory 904 and/or within the processing device 902 during execution thereof by the computer system 900, the main memory 904 and the processing device 902 also constituting machine-readable storage media.

The computer-readable storage medium 924 may also be used to store the instructions 926 persistently. While the computer-readable storage medium 924 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing or encoding a set of instructions for execution by the machine and that cause the machine to perform any one or more of the methodologies of the present invention. The term “computer-readable storage medium” shall accordingly be taken to include, but not be limited to, solid-state memories, and optical and magnetic media.

The instructions 926, components and other features described herein can be implemented as discrete hardware components or integrated in the functionality of hardware components such as ASICS, FPGAs, DSPs or similar devices. In addition, the instructions 926 can be implemented as firmware or functional circuitry within hardware devices. Further, the instructions 926 can be implemented in any combination hardware devices and software components.

In the above description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “providing,” “generating,” “installing,” “monitoring,” “enforcing,” “receiving,” “logging,” “intercepting,” “computing,” “calculating,” “determining,” “presenting,” “processing,” “confirming,” “publishing,” “receiving,” “applying,” “detecting,” “selecting,” “updating,” “assigning,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices. In addition, unless specifically stated otherwise as apparent from the following discussion, it is appreciated that throughout the description, discussions utilizing terms such as “manager,” “receiver,” “generator,” “tracker,” “biaser,” “calculator,” “associator,” detector,” “publisher,” or the like, refer to processes operating on a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

It is to be understood that the above description is intended to be illustrative, and not restrictive. Many other embodiments will be apparent to those of skill in the art upon reading and understanding the above description. Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense. The scope of the invention should, therefore, be determined with reference to the appended claims, along with the full scope of equivalents to which such claims are entitled.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer. Embodiments of the invention can take the form of an entirely hardware embodiment, an entirely software embodiment, or an embodiment containing both hardware and software elements. In one embodiment, the invention is implemented in software, which includes but is not limited to firmware, resident software, microcode, etc.

Furthermore, embodiments of the invention can take the form of a computer program product accessible from a computer-usable or computer-readable storage medium providing program code for use by or in connection with a computer or any instruction execution system. For the purposes of this description, a computer-usable or computer readable storage medium can be any apparatus that can store the program for use by or in connection with the instruction execution system, apparatus, or device.

The computer-useable or computer-readable storage medium can be an electronic, magnetic, optical, electromagnetic, infrared, or semiconductor system (or apparatus or device), or a propagation medium. Examples of a computer-readable storage medium include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

An embodiment of a data processing system suitable for storing and/or executing program code includes at least one processor coupled directly or indirectly to memory elements through a system bus such as a data, address, and/or control bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Additionally, network adapters also may be coupled to the system to enable the data processing system to become coupled to other data processing systems or remote printers or storage devices through intervening private or public networks. Modems, cable modems, and Ethernet cards are just a few of the currently available types of network adapters.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. An audio router comprising:
a media director comprising a plurality of nodes;
wherein each node of the plurality of nodes is configured to receive a signal containing audio information from a source external to the audio router;
wherein each node of the plurality of nodes comprises:
a network transceiver configured to communicate over a data network;
an advertisement module configured to advertise availability of the node on the data network; and
an audio transmission module configured to transmit the signal containing audio information.

2. The audio router of claim 1, wherein the advertisement module is configurable to advertise the availability of the node as an audio endpoint compliant with an audio streaming standard.

3. The audio router of claim 1, wherein the advertisement module is configurable to advertise the availability of the node as a zone for delivering audio to one or more predetermined playback devices.

4. The audio router of claim 1, further configured to:
transmit the signal containing audio information from the node to a plurality of additional nodes;
wherein each of the plurality of additional nodes is configured to output audio to a playback zone, wherein each playback zone comprises at least one playback device configured to receive the signal containing audio information and produce audio based on the signal;
wherein the node is configured to provide playback of audio over each of the playback zones connected to all of the additional nodes.

5. The audio router of claim 1, wherein the media director is configured to:
simultaneously receive a first audio source at a first node of the plurality of nodes and a second audio source at a second node of the plurality of nodes;
transmit an audio signal derived from the first audio source to a first zone of playback devices;
transmit an audio signal derived from the second audio source to a second zone of playback devices.

6. The audio router of claim 1, wherein the signal containing audio information is received from an internet transmitted digital streaming audio source.

7. The audio router of claim 1, wherein the audio transmission module is configured to transmit the signal containing audio information to a playback device.

8. The audio router of claim 7, wherein the playback device consists of a playback device selected from the group consisting of a speaker, a television, a sound bar, a subwoofer, a mobile device, and an intercom.

9. The audio router of claim 1, wherein the audio transmission module further comprises an audio matrix switch configured to route the signal containing audio information to predetermined amplification channels.

10. The audio router of claim 1, wherein the audio transmission module further comprises an audio preprocessor.

11. The audio router of claim 1, wherein the audio transmission module further comprises a plurality of amplification channels.

12. The audio router of claim 1, wherein the network transceiver is a wireless network transceiver and the data network is a wireless data network.

13. The audio router of claim 1, wherein the node comprises a system on a chip.

14. A system for audio playback comprising:
an audio router comprising:
a media director comprising a plurality of nodes;
wherein each node of the plurality of nodes is configured to receive a signal containing audio information from a source external to the audio router;
each node of the plurality of nodes comprising:
a network transceiver configured to communicate over a data network;
an advertisement module configured to selectively advertise availability of the node on the data network as:
a zone for delivering audio to one or more predetermined playback devices; and
an audio endpoint compliant with an audio streaming standard; and
an audio transmission module configured to transmit the signal containing audio information; and
one or more playback devices configured to receive the audio signal transmitted by the audio transmission module and produce audio derived from the audio signal.

15. The system of claim 14, further comprising a networkable user device.

16. The system of claim 14, wherein a plurality of playback devices of the one or more playback devices are arbitrarily grouped into a zone and wherein the audio router transmits the same audio signal to each of the plurality of playback devices substantially simultaneously.

17. A method of playing audio in one or more playback zones, the method comprising:
connecting an audio router to a network, the audio router comprising:
a media director comprising a plurality of nodes;
wherein a first node of the plurality of nodes is configured to receive a signal to reproduce audio from a source external to the audio router; the first node comprising:
a network transceiver configured to communicate over a data network;
an advertisement module configured to advertise availability of the node on the data network as a zone for delivering audio to a second node and a third node; and
an audio transmission module configured to transmit the signal containing audio information from the first node to the second node and the third node;
configuring the second node to output the signal containing audio information to a first playback zone;
configuring the third node to output the signal containing audio information to a second playback zone;
wherein the first playback zone and the second playback zone each comprise at least one playback device configured to play audio in response to the signal containing audio information transmitted by the first node.

18. The method of claim 17, further comprising connecting a plurality of amplification channels of the audio transmission module to the audio router.

19. The method of claim 17, wherein the second node is a component of a second audio router.

20. The method of claim 17, wherein the second node and the third node are each one of the plurality of nodes of the audio router.
